(19) United States
(12) Patent Application Publication
(10) Pub. No.: US 2013/0179023 A1
(43) Pub. Date: Jul. 11, 2013

(54) METHODS FOR INFORMING A MOTOR VEHICLE DRIVER OF A DRIVING MANEUVER, A DRIVER ASSISTANCE SYSTEM FOR A MOTOR VEHICLE THAT UTILIZES THE METHOD, AND A MOTOR VEHICLE HAVING THE DRIVER ASSISTANCE SYSTEM

(71) Applicant: GM GLOBAL TECHNOLOGY OPERATIONS LLC, Detroit, MI (US)

(72) Inventor: Gerald SCHMIDT, Frankfurt am Main (DE)

(73) Assignee: GM GLOBAL TECHNOLOGY OPERATIONS LLC, Detroit, MI (US)

(21) Appl. No.: 13/722,404

(22) Filed: Dec. 20, 2012

(30) Foreign Application Priority Data
Dec. 22, 2011 (DE) 102011121948.3

(51) Int. Cl. G05D 1/02

(52) U.S. Cl. CPC G05D 1/021
USPC 701/23

(57) ABSTRACT

A method for informing a motor vehicle driver of a driving maneuver planned by a driver assistance system of a motor vehicle and carried out by the motor vehicle, a driver assistance system for a motor vehicle that utilizes the method, and a motor vehicle with the driver's assistance system are provided. The method includes detecting current environmental data of the environment lying ahead of the motor vehicle by a detection means, planning and carrying out the driving maneuver on the basis of the environmental data, and reproducing the driving maneuver and at least a portion of the detected environmental data in an image on a display.

### CROSS-REFERENCE TO RELATED APPLICATION

This application claims priority to German Patent Application No. 10 2011 121 948.3, filed Dec. 22, 2011, which is incorporated herein by reference in its entirety.

### TECHNICAL FIELD

The technical field relates to a method for informing a motor vehicle driver of a driving maneuver planned by a driver assistance system of a motor vehicle and carried out by the motor vehicle, a driver assistance system for a motor vehicle that utilizes the method, and a motor vehicle with the driver's assistance system.

### BACKGROUND

Driver assistance systems are known which assist a motor vehicle driver when driving a motor vehicle, for example by a cruise control, by a distance warning system, or by providing a power steering assist signal. Further driver assistance systems enable, at least in particular driving situations, for example on the freeway, the autonomous driving of the motor vehicle, i.e. the driving of the motor vehicle without the influence of the motor vehicle driver. Such driver assistance systems compare in most cases environmental parameters, which are detected by them, with desired values. If the current environmental parameters correspond to the desired values, the driver assistance systems assist the vehicle driver

In the case of an autonomous driver assistance system, the environment in front, behind and/or to the side of the motor vehicle is detected by means of radar, ultrasound and/or camera systems, and the lane, the type of road and/or individual objects and further data relevant to travel, such as for example the alignment and the steering of the motor vehicle are determined. Individual objects are to be understood here as other vehicles, people and/or obstacles.

In the future, such driver assistance systems are to enable the travelling of an arbitrary route irrespective of the current traffic situation and without any intervention by the motor vehicle driver. Owing to the plurality of environmental parameters which are to be taken into account, this problem is very complex, however. Nevertheless, such driver assistance systems are already making it possible that a motor vehicle travels autonomously through particular driving situations, for example, following behind a vehicle which is travelling ahead, or a passing maneuver in low traffic density. However, such driver assistance systems have hitherto come up against limits in which the autonomous driving through a driving situation is not possible, and an intervention of the vehicle driver becomes necessary.

The publication DE 198 21 163 discloses a method for operating a driver assistance system which detects predetermined environmental parameters in order to activate or deactivate the driver assistance system as a function of the currently detected environmental parameters compared with desired values. The system makes provision that the vehicle driver is informed as to whether the system is already active or not.

Building trust in these driver assistance systems is only able to be achieved with difficulty.

It is at least one object herein to make available a driver assistance system that remedies this deficiency and enables the building of trust in the system.

### SUMMARY

A method for informing a vehicle driver of a driving maneuver that is planned by a driver assistance system of a motor vehicle and is currently carried out by the motor vehicle is provided. The driver assistance system cyclically detects current environmental data of the environment of the motor vehicle by a detection means, plans and carries out the driving maneuver on the basis of the currently detected environmental data, and reproduces the currently carried out driving maneuver and at least a portion of the detected environmental data in an image on a display.

The detection means is preferably arranged in or on the motor vehicle and is directed forward onto the lane and/or onto the edge of the roadway, so that in addition to the vehicles, people or other obstacles situated on the roadway, traffic signs arranged at the edge of the roadway and people or vehicles standing at the edge of the roadway are also able to be detected by it. In a preferred embodiment, the driver assistance system, when planning the driving maneuver, in addition detects and takes into account the rear and/or lateral environment of the motor vehicle, wherein the detection means in this embodiment also detects the lateral and rear environment of the motor vehicle. The environment in the direction of travel of the motor vehicle is designated here as the environment lying ahead.

In an embodiment, the detection means for determining the current environmental data detects the current image data cyclically, i.e. in an image series. The cyclic detection enables a constant updating of the presented image. It is thereby possible to compensate for concealments, which are caused for example by vehicles parking at the edge of the roadway or by rain or fog. This procedure also ensures a high detection rate in poor visibility conditions.

As the environment lying ahead of the motor vehicle is detected by the camera, the method enables an anticipatory assistance of the driver. Depending on the range of the detection means and the weather conditions, an early informing of the driver is possible if the driving maneuver is not able to be carried out autonomously by the driver assistance system.

One or more cameras and/or radar systems and/or ultrasound systems and/or further detection means are preferred as detection means for detecting the environmental data. These detection means detect the driving event and/or the roadway in front of, adjacent to and/or behind the vehicle. In addition, it is preferred to also use data of further detection means such as for example GPS systems, car to car or car to infrastructure systems.

In an embodiment, a processing of the current environmental data takes place in digital form, so that it is possible very quickly and with great precision.

In a preferred embodiment, the driver assistance system plans in addition a future driving maneuver on the basis of the detected environmental data, and reproduces the feasibility of the future driving maneuver in the image. A future driving maneuver is a driving maneuver which is to be carried out on the basis of the detected environmental data, for example on the basis of an obstacle on the roadway, and/or on the basis of an input of the motor vehicle driver, for example on the basis of an applying of a blinker. In this embodiment, it is in addition immediately discernible for the motor vehicle driver as to whether the driving maneuver, which is to be carried out in future, is able to be carried out autonomously by the driver assistance system or not.

The presentation of the driving maneuver currently carried out and the presentation of the future driving maneuver differ from one another by color and/or structurally, so that they are able to be differentiated by the motor vehicle driver.

In a preferred embodiment, the presentations of the reproduced environmental data and/or of the driving maneuvers differ in color and/or structurally in the image in the case of environmental data which are detected as being implausible, from a presentation of the reproduced environmental data and/or of the driving maneuvers in the case of environmental data which are detected as being plausible.

Environmental data that are detected as being implausible in the sense of the invention are incompletely or obviously incorrectly detected environmental data, which for example owing to limits of the available detection means are not able to be detected completely or are only able to be detected incorrectly. Such limits occur for example in camera systems owing to a lack of contrast, especially in the case of reduced visibility. However, incompletely detectable environmental data are also present in the case of a lack of traffic instructions, for example a lack of roadway marking.

Through the figurative presentation of the planned driving maneuver and the detected environmental data, and owing to the colored and/or structural differentiation between environmental data detected to be plausible and environmental data detected to be implausible, the motor vehicle driver is already alerted at an early stage to the limits of the driver assistance system, and he recognizes whether the planned and/or future driving maneuver is able to be carried out autonomously or not. He can also assure himself at an early stage of the error-free planning of the driving maneuver(s) and therefore of the quality of the planning, or he can recognize an erroneous or undesired planning and can act accordingly. As environmental data that are present as being implausible are able to be recognized by the colored and/or structural differentiation, if applicable also the reasons for a driving maneuver that is not able to be carried out autonomously are also able to be recognized. The method therefore enables the motor vehicle driver to detect the quality of the planning.

The detected and reproduced environmental data preferably comprise at least the course of the roadway and/or a boundary of the roadway, so that the spatial data and the lanes that are available are known. Through the colored and structural differentiation between a roadway course which is detected as being plausible and one which is detected as being implausible, it is immediately recognizable for the motor vehicle driver if the driving maneuver is not able to be planned completely or is only able to be planned deficiently owing to the incompletely detected roadway course and/or the incompletely detected roadway boundary or marking.

In addition, the detected environmental data preferably comprise people, vehicles and/or further obstacles and their relative position to the motor vehicle. These people, vehicles and/or obstacles are preferably classified into image objects and are marked or presented accordingly by color and/or structurally in the image. The classification preferably comprises a weighting in accordance with the relevance of the detected data, by means of which the presentation is altered, so that the attention of the motor vehicle driver, for example in an acute hazard situation, is particularly alerted.

The planned driving maneuver and the presented environmental data are therefore preferably presented in the image respectively by an image object, for example by a line, an arrow, a box, a structured area, a circle or a wheel or pair of wheels. Particularly preferably, the same image objects are always used for the presentation of the respective environmental data. The image objects preferably differ from one another by color and/or structurally so that the traffic situation is able to be detected very quickly and easily by the motor vehicle driver by means of the image objects. The weighting can take place for example in that the image object which is used for the detected environmental data is presented brighter, darker or flashing, according to weighting.

The method preferably detects in addition driver-relevant data and takes these into account in the planning of the driving maneuver. Driver-relevant data are, especially, the steering wheel position, a blinker position and/or a pedal position of a gas, brake and/or clutch pedal. Thereby, an intervention of the motor vehicle driver is detected and is taken into account in the planning of the driving maneuver.

For planning the driving maneuver, a comparison is carried out of the detected environmental data and of the detected driver-relevant data with desired values. A driving maneuver is able to be carried out autonomously when the necessary environmental data are present and correspond to the desired values. Driving maneuvers which are able to be carried out autonomously are, for example, following behind a vehicle which is travelling ahead, changing lane, exiting from a roadway or passing another vehicle. Particularly preferably, the driver assistance system also enables evasion maneuvers.

In a preferred embodiment, the implausible presence of the environmental data is indicated in addition acoustically and/or haptically, so that the motor vehicle driver is immediately alerted that his intervention into the current driving maneuver is necessary, if applicable. In so far as, in particular owing to implausible environmental data, a hazard situation is detected, it is preferred that an acoustic, haptic and/or visual warning signal is issued until the motor vehicle driver intervenes in the driving maneuver.

In another embodiment, a driver assistance system for a motor vehicle for carrying out the method is provided. The driver assistance system comprises a driving system by which a driving maneuver is able to be planned and is able to be carried out autonomously as a function of detected environmental data, and wherein the driver assistance system in addition comprises a display which is provided for the reproduction of an image in which the driving maneuver which is currently being carried out and at least a portion of the detected environmental data are presented figuratively.

The presentation of the planned driving maneuver and of the detected environmental data enables the motor vehicle driver to estimate at an early stage whether the driving maneuver is able to be carried out or is thus desired by him.

Preferably, the display shows in addition a future planned driving maneuver, and therefore a planned alteration to the current driving maneuver, which is to take place for example on the basis of the currently detected environmental data and/or an intervention of the motor vehicle driver.

In order to detect the intervention of the motor vehicle driver, the driving system has an interface for the detection of driver-relevant data. Via the interface, the driving system detects steering movements, the application of a blinker, the actuation of a pedal and/or further actions of the motor vehicle driver, such as for example the actuation of the upper beam or the horn. Thereby, it is possible for the motor vehicle driver to intervene immediately into the driving maneuver and to bring about an alteration or an interruption to the driving maneuver.

The detected environmental data preferably comprise:
A roadway boundary,
A roadway course,
Obstacles on the roadway, vehicles and people,
A roadway status,
A road type, for example freeway, highway, urban area, country road,
Traffic signs, stoplights, bus stops and/or further traffic notices,
Visibility and weather conditions, and
Traffic density, for example normal traffic or stop and go traffic.

In an embodiment, the autonomous carrying out of some of the driving maneuvers with the aid of the driver assistance system is limited to certain types of road.

In a further embodiment, a rain sensor or for example the switching on of the light by the motor vehicle driver is detected and taken into account as an indication of the prevailing weather and visibility conditions.

In a preferred embodiment, the driver assistance system comprises as display a projector for the reproduction of the image, which projects the image onto a projection area of the motor vehicle. In an embodiment, a windshield is used as projection area. Preferably, the display is configured as a head up display. In this embodiment, it is preferred to detect the eye position of the motor vehicle driver and to adjust it with the image projected by the projector onto the windshield such that the image projected onto the windshield appears for the motor vehicle driver as an overlay of the actual driving event. The image is therefore visible simultaneously with the driving event in the direction of travel of the motor vehicle. In this regard, the motor vehicle driver can observe the planned driving maneuver simultaneously with the driving event. Thereby, he sees immediately whether the current driving maneuver is able to be carried out, or not. In addition, he is not distracted from the driving event by observing another display.

In this embodiment, the current driving maneuver in the current traffic situation is presented by an image object, such as for example a line or an arrow. Preferably, in addition the available driving space is highlighted by a colored and/or structural marking. For this, the roadway markings and boundaries present in the current traffic situation are marked by lines and/or borders.

Furthermore, it is preferred that people, vehicles, obstacles, traffic signs or similar are classified into image objects. The term classification includes here on the one hand an allocation according to its type, namely for example moving or stationary object, or person, truck, specialty vehicle, motorcycle, automobile, traffic sign or similar. On the other hand, the term classification also includes a weighting in relation to the relevance, in particular for the current and/or future driving maneuver.

These image objects are marked, or not, depending on their weighting. A marking takes place also here by a border, hatching or similar. This procedure simplifies the detecting of the driving maneuver and the environment relevant for this. On the other hand, the motor vehicle driver observes through the windshield the actual traffic event and can therefore immediately notice changes which possibly have not yet even been classified as relevant by the driver assistance system, and can react accordingly.

Basically, however, another display arranged in the cockpit of the motor vehicle is also able to be used. It is then preferred to use as the display a display which is also used for the presentation of other functions, for example for operating the radio and/or as navigation equipment.

The image presented on such a display preferably comprises at least the course of the roadway and the roadway boundaries. In addition, it is preferred to present the driving maneuver by an arrow, rotating wheels or a line. Furthermore, the presented image preferably indicates vehicles and people present in the current driving event. In a preferred embodiment, it presents in addition traffic signs, bus stops, stoplights, crosswalks and/or further traffic notices. It is preferred to fade in and out the information presented in the display as a function of the planned driving maneuver, so that the complexity of the image is as little as possible and the image is able to be detected by the motor vehicle driver as easily as possible. Thereby, the motor vehicle driver is distracted as little as possible from the actual driving event. In addition, it is preferred that the generated image comprises further data, such as for example a warning notice when a driving maneuver is not able to be carried out owing to implausible environmental data.

Irrespective of the configuration of the display, it is preferred, in the case of implausible environmental data, to alter the image such as for example the arrow, line or similar, which present the current and/or future driving maneuver, by color and/or structurally with respect to the image object in the case of plausibly detected environmental data, so that the motor vehicle driver is notified especially of this traffic situation. In a further embodiment, an additional visual warning notice can be issued in the display.

The driver assistance system preferably further comprises a signal means for the issuing of an acoustic or haptic warning signal, which supports the visual presentation and either signals the feasibility or the non-feasibility of the current and/or future driving maneuver. It is preferred that the signal means in the case of implausible environmental data always issues a warning notice, particularly preferably until the motor vehicle driver intervenes into the driving maneuver. As acoustic warning notice, for example, an issuing of a signal tone or a spoken text is preferred, as haptic warning signal for example a vibrating of the seat.

For the detection of the environmental data and the driver-relevant data, and for the planning of the driving maneuver, the autonomous driving system preferably comprises a processing unit, which is also provided for the controlling of the display.

In order to save on installation space and costs, the processing unit is preferably constructed as a microcontroller, in which required periphery functions are at least partially integrated. Preferably, the controller and driver are integrated for the connecting of the display, of a data memory for the storage of desired parameters and/or currently detected environmental data, of the interface for the detection of driver-relevant data and/or for driver-specific settings. Basically, however, a realization of the processing unit with separate periphery components and if applicable with a microprocessor instead of the microprocessor is also possible.

In a further embodiment, a motor vehicle with a driver assistance system as contemplated herein is provided. In a preferred embodiment, the motor vehicle has as a display a projector which is arranged between a vehicle steering arrangement, in particular a steering wheel, and a windshield. The projector projects an image onto the windshield so that it is visible by the motor vehicle driver simultaneously with the actual traffic event.

### BRIEF DESCRIPTION OF THE DRAWINGS

The various embodiments will hereinafter be described in conjunction with the following drawing figures, wherein like numerals denote like elements, and wherein:

FIG. 1 shows images respectively presented on a display of a driver assistance system according to an embodiment, which present a currently carried out driving maneuver, wherein the currently carried out driving maneuver in FIG. 1 (a)-(d) is a travel straight ahead;

FIG. 2 shows in (a)-(d) respectively as currently carried out driving maneuvers a travel through a left or respectively right bend;

FIG. 3 shows in (a) an erroneously planned currently carried out driving maneuver, namely a travel straight ahead, although the roadway runs in a left bend, and in (b)-(e) respectively an incompletely planned travel straight ahead owing to absent environmental parameters;

FIG. 4 shows in (a) as current driving maneuver a travel straight ahead, which is altered in (b) by an intervention of the motor vehicle driver into a turning-off maneuver;

FIG. 5 shows as current driving maneuver a following by the motor vehicle behind a motor vehicle travelling ahead, and the planning of a future driving maneuver, namely a passing maneuver of the motor vehicle which is travelling ahead; and

FIG. 6 shows diagrammatically a cut-out of a motor vehicle with a driver assistance system according to an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

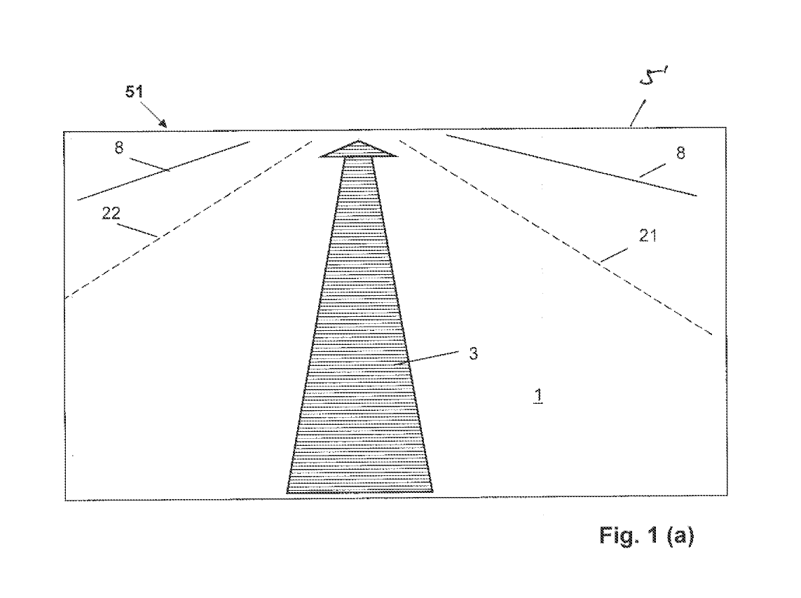

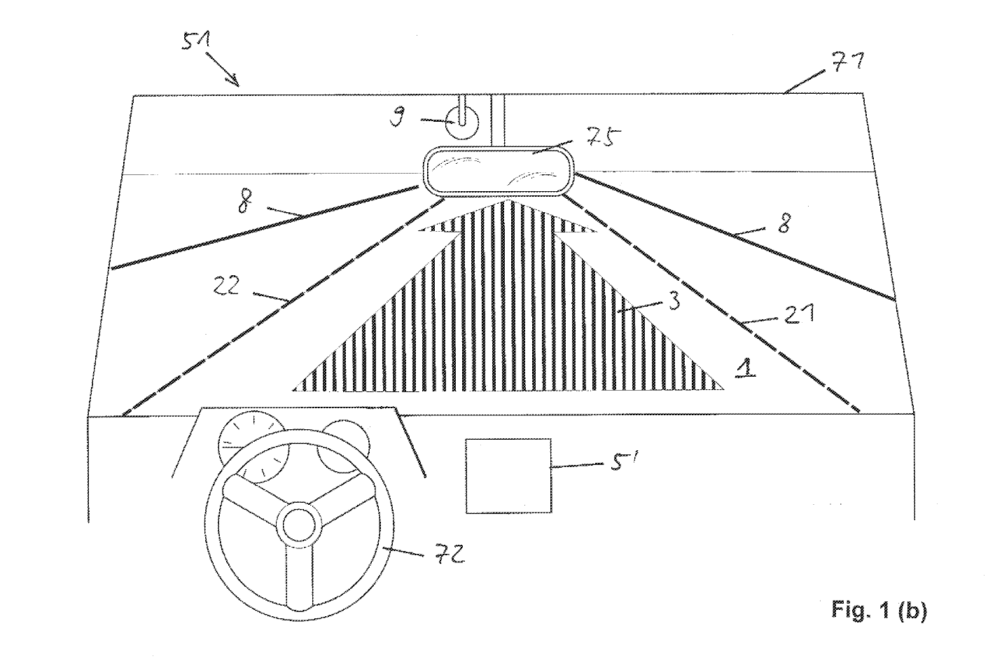

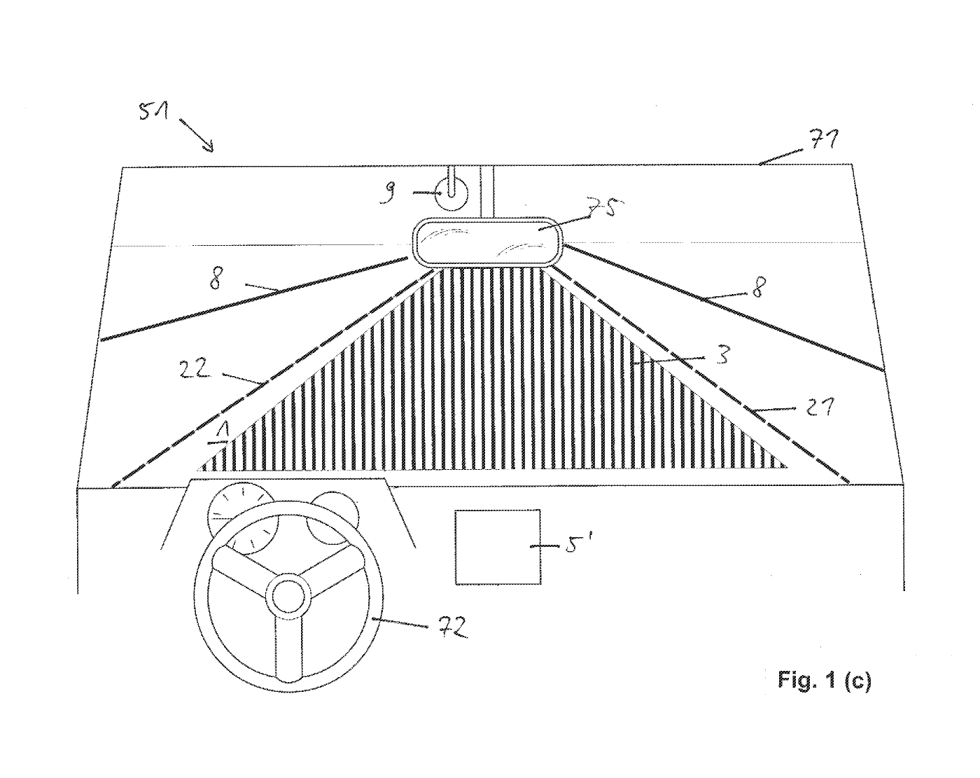

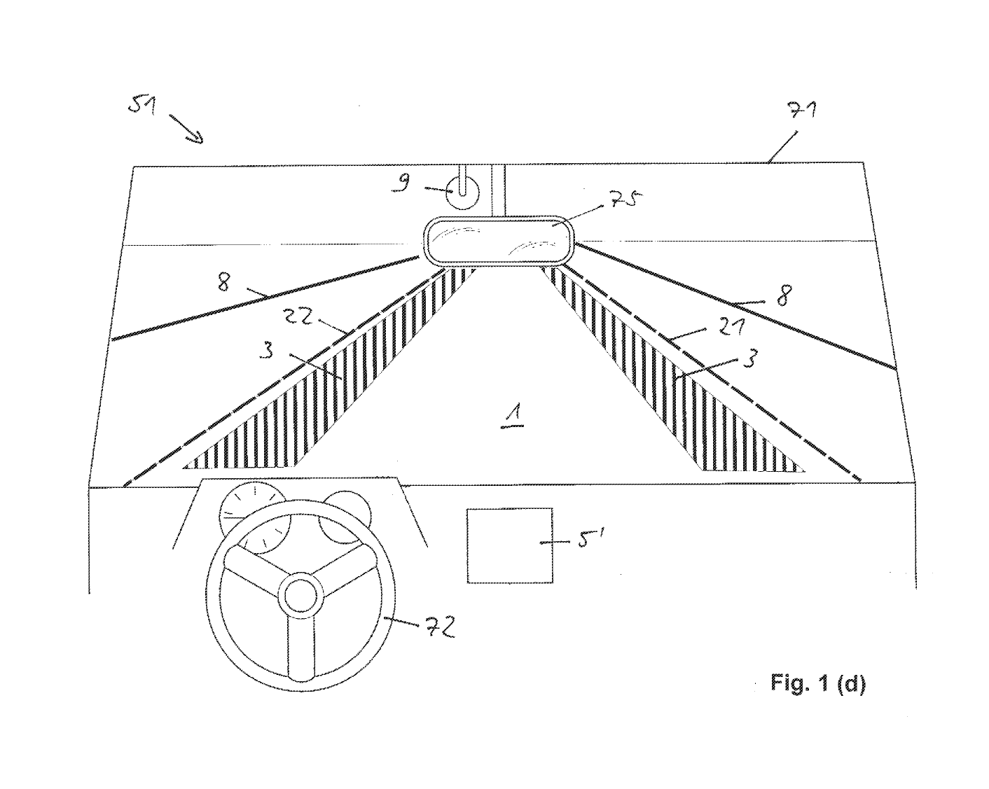

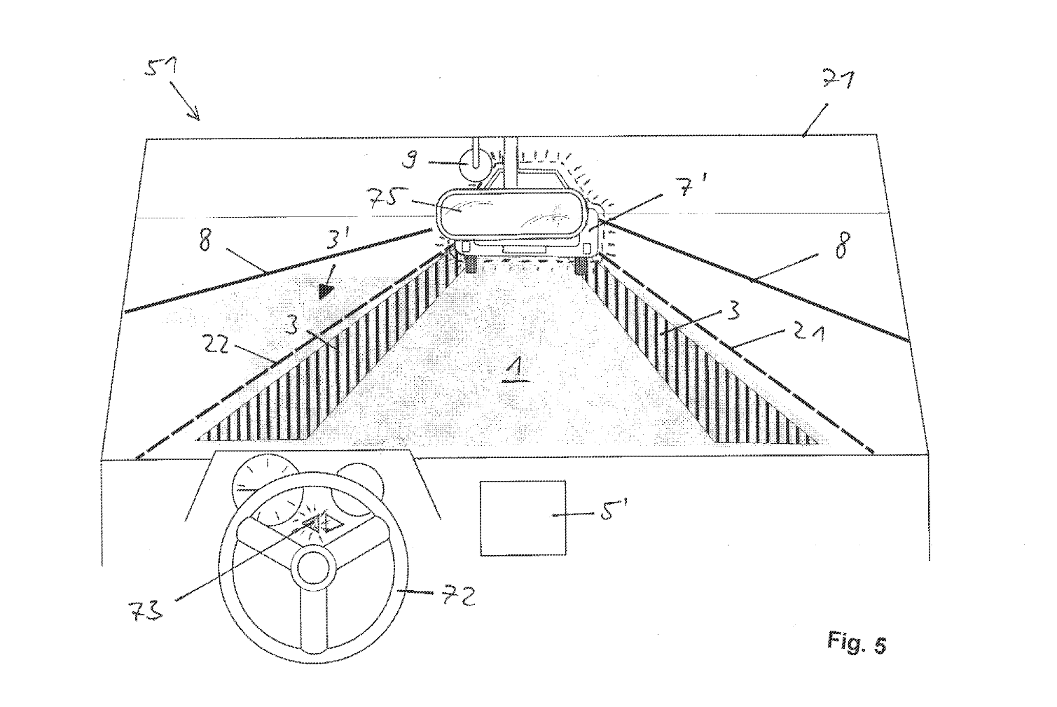

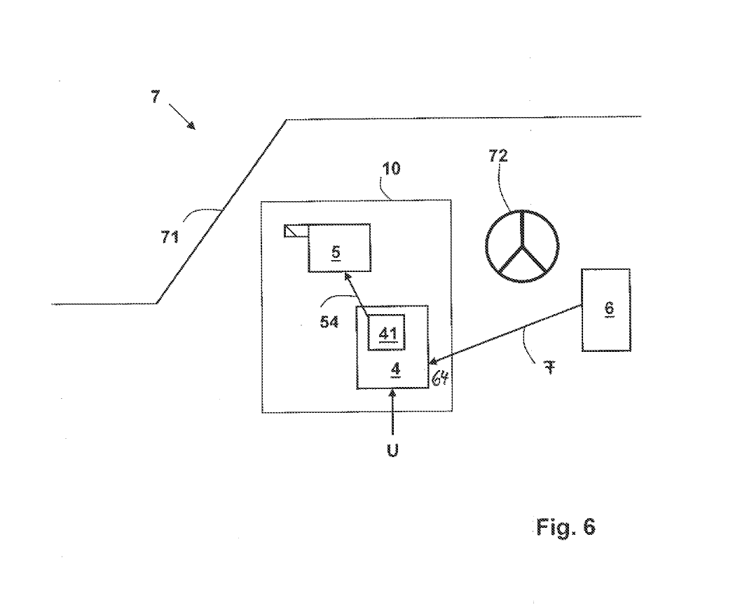

In FIG. 1(a) an image 51 of a display 5 is shown diagrammatically, which is also able to be used for other purposes in a motor vehicle 7 (see FIG. 6). Such a display 5 is, for example a display which is also able to be used for a navigation system (not shown) or a multimedia system (not shown). In FIG. 1(b)-(d), in contrast, the view through a windshield 71 is shown, onto which a projector (see FIG. 6) used as display 5 projects its image 51.

FIG. 1 shows a roadway 1 with a straight roadway course, which is presented by continuous lines 8 as image objects. In addition, a left roadway marking 22 and a right roadway marking 21 are presented by dashed lines as image objects. It is preferred that the lines are presented in accordance with their actual course on the roadway 1. This means that with a continuous roadway marking the roadway boundary 21, 22 is also presented continuously in the display 5, and with interrupted roadway marking the roadway boundary 21, 22 is also presented by interrupted lines in the display 5. In addition, it is preferred that the roadway boundary 21, 22 differs in color from the roadway course 8.

Furthermore, the display 5 presents an arrow 3, which is used as image object for the current driving maneuver. In the present example, the current driving maneuver 3 is a travel straight ahead within the roadway boundary 21, 22.

The example embodiments of FIG. 1(b)-(c), in contrast to FIG. 1(a), show a view through a windshield 71 of the motor vehicle 7, so that a motor vehicle driver 6 (see FIG. 6) directly sees the roadway 1, the roadway course 8 and the roadway boundaries 21, 22, and these do not compulsorily have to be presented on the windshield 71 by the display 5. Depending on the traffic situation and/or the current or a future driving maneuver 3,3′ it is, however, preferred that the roadway 1, the roadway course 8 and/or the roadway boundaries 21, 22 are highlighted or marked in the image 51 by image objects, for example by being highlighted in color or presented by an in particular two-dimensional structure.

The image 51 of FIG. 1(b)-(d) shows that the roadway boundaries 21, 22 and the roadway course 8 are deposited by lines as image objects, so that they are able to be detected very quickly by the motor vehicle driver 6.

The current driving maneuver 3 is presented by various image objects in the three presentations of FIG. 1(b)-(d). In FIG. 1(b) it is by an arrow which extends within the roadway, in FIG. 1(c) by a structured area within the roadway, and in FIG. 1(d) by two structured areas running laterally along the roadway boundaries and within the roadway.

FIG. 1(b)-(d) show in addition respectively a view of the motor vehicle driver 6 onto the cockpit of the motor vehicle.

In the cockpit a camera 9 is provided to the side of a rear view mirror 75, which camera is provided as detection means for the detection of the environment lying ahead. Also shown are steering wheel 72 of the motor vehicle 7 and a display 5′, also able to be used for a navigation system or a multimedia system, as is able to be used for an image 51 in accordance with FIG. 1(a).

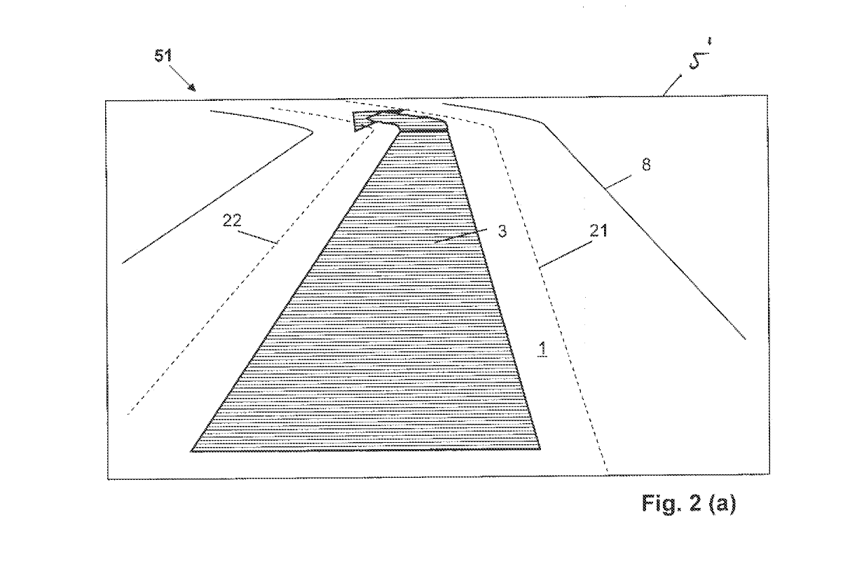

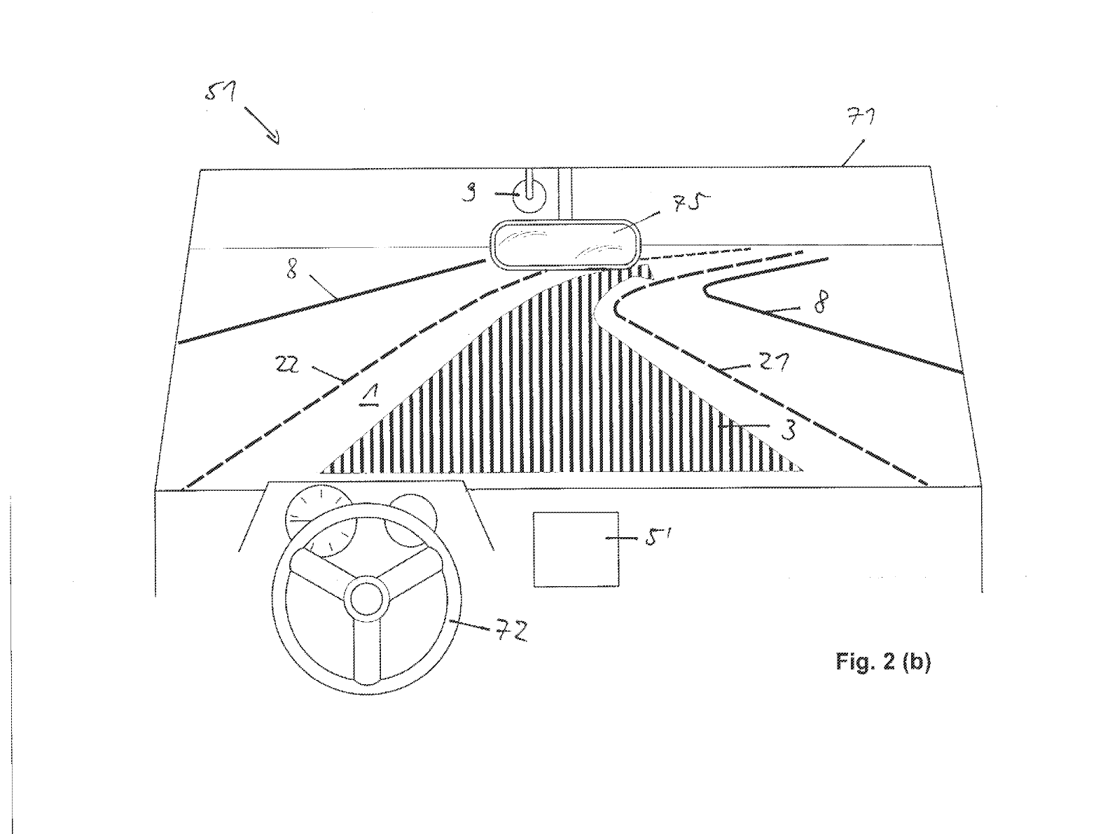

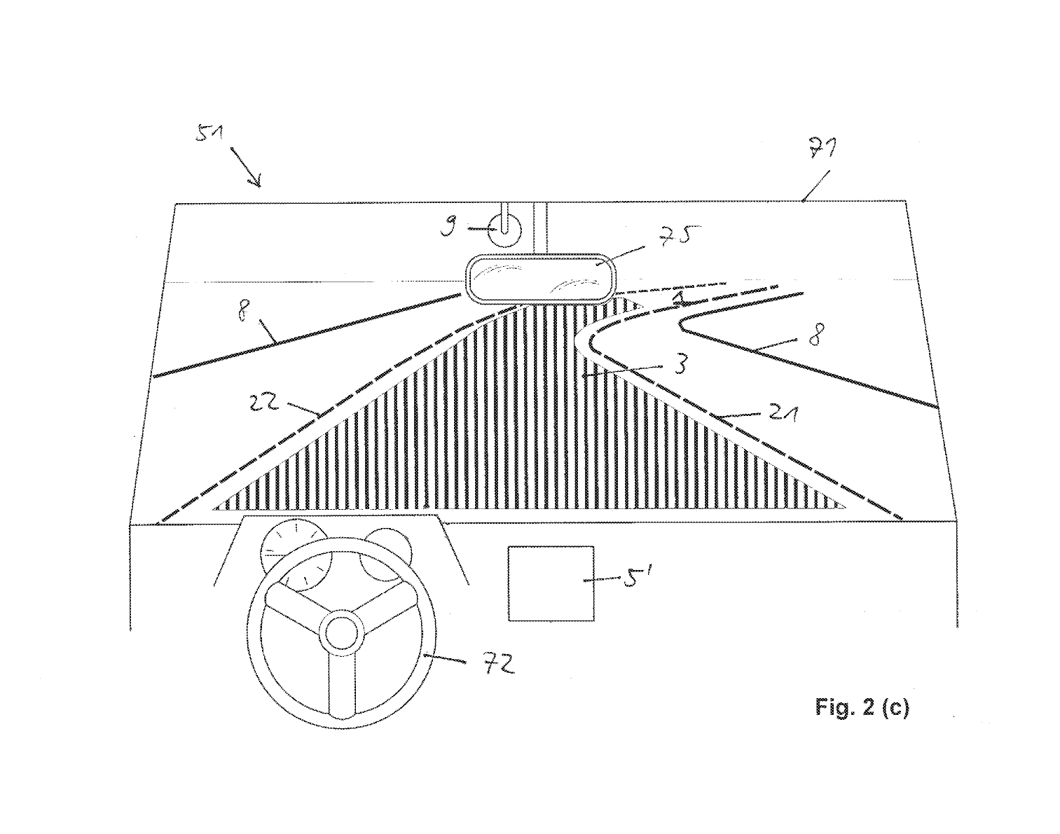

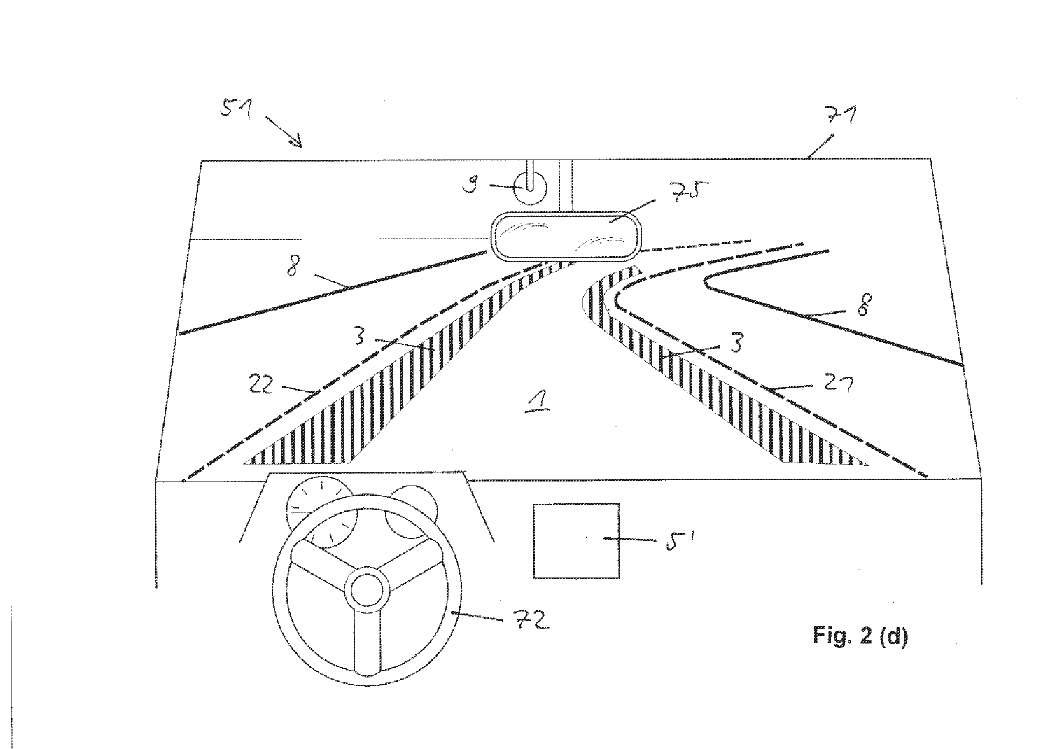

The examples of FIG. 2 show the image in an analogous manner to the examples of FIG. 1, with the difference that here as current driving maneuver 3 the driving along a left bend is presented in FIG. 2(a) or respectively along a right bend in FIG. 2(b)-(d). Accordingly, FIG. 2(a) shows the image 51 presented in a display 5 which is also able to be used for other functions, and FIG. 2(b)-(d) show respectively the view through the windshield 71, wherein in the images 51 respectively the same image objects are selected for the same environmental parameters U, and wherein the image object for the current driving maneuver 3 differs accordingly.

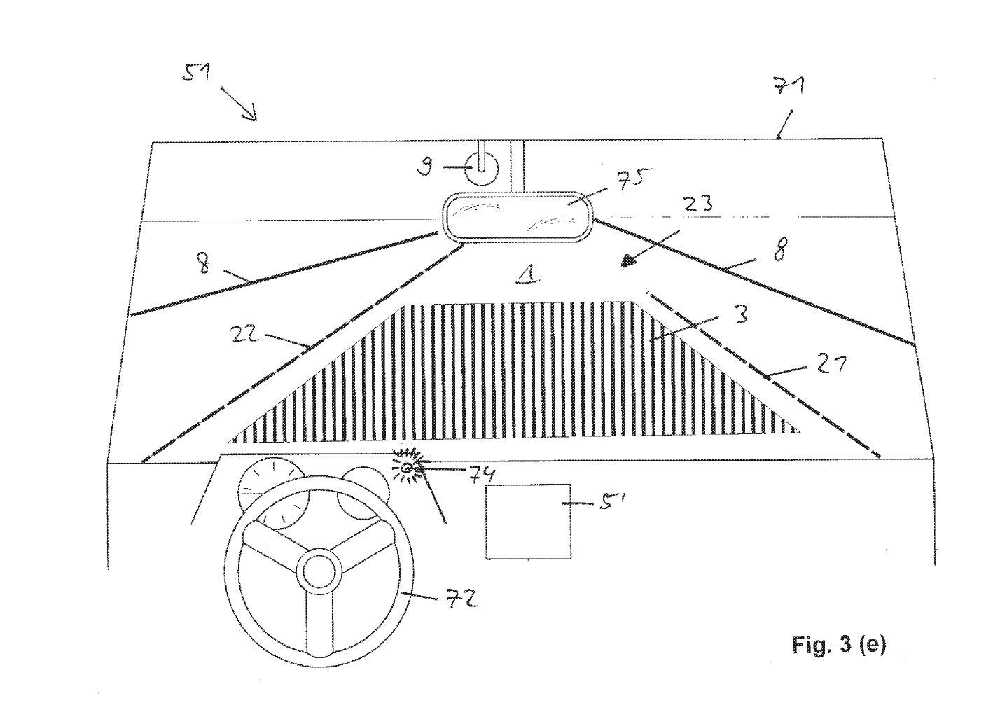

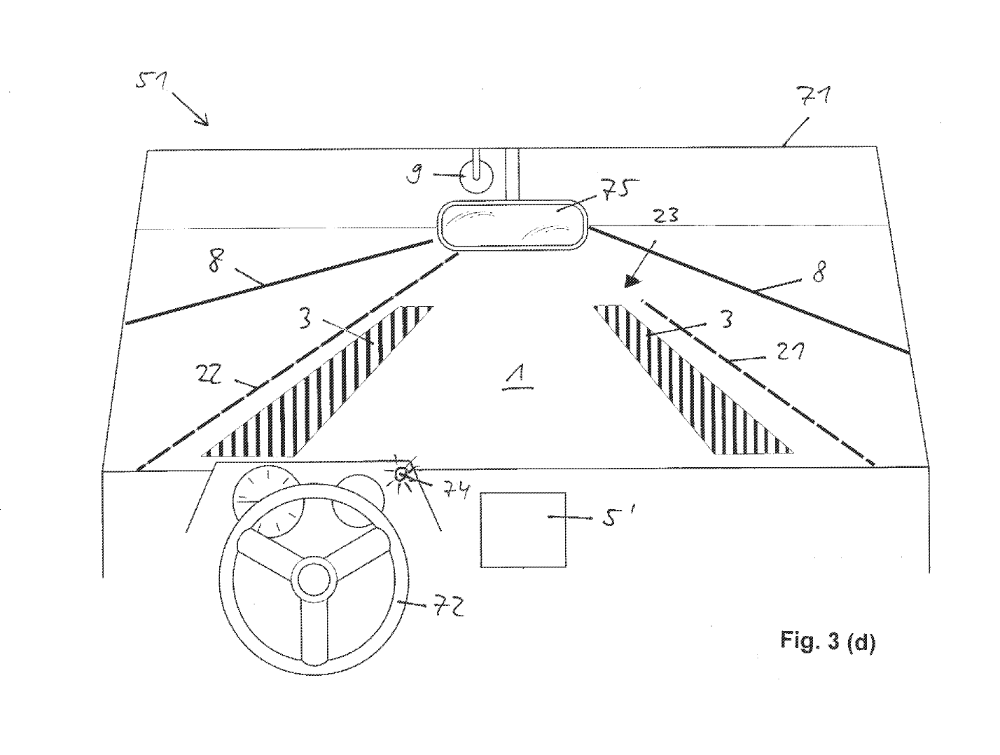

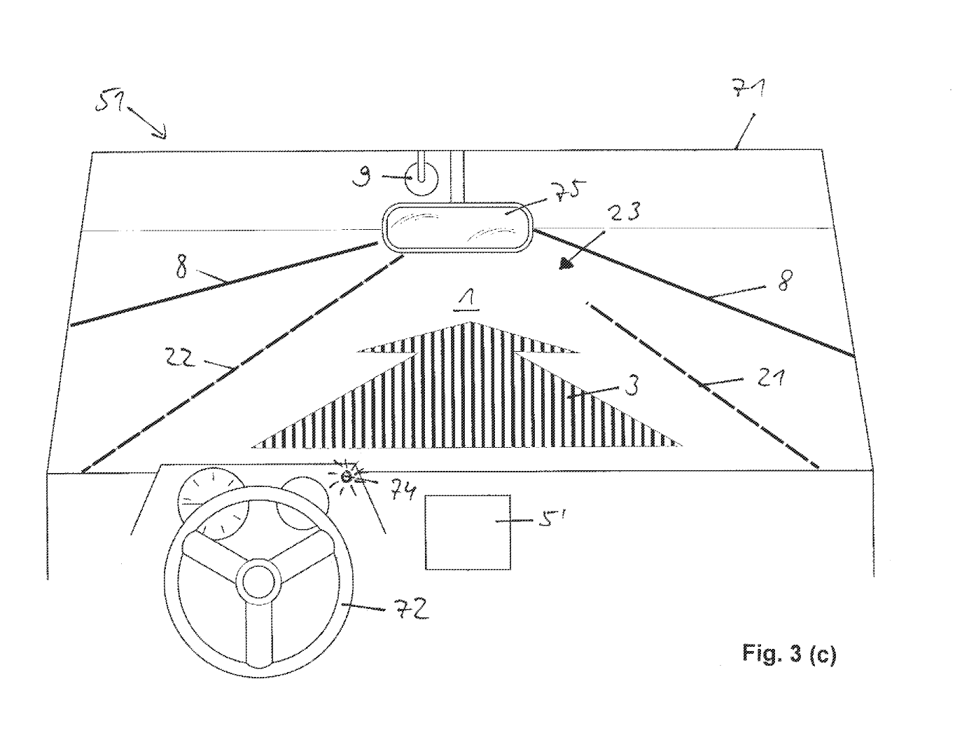

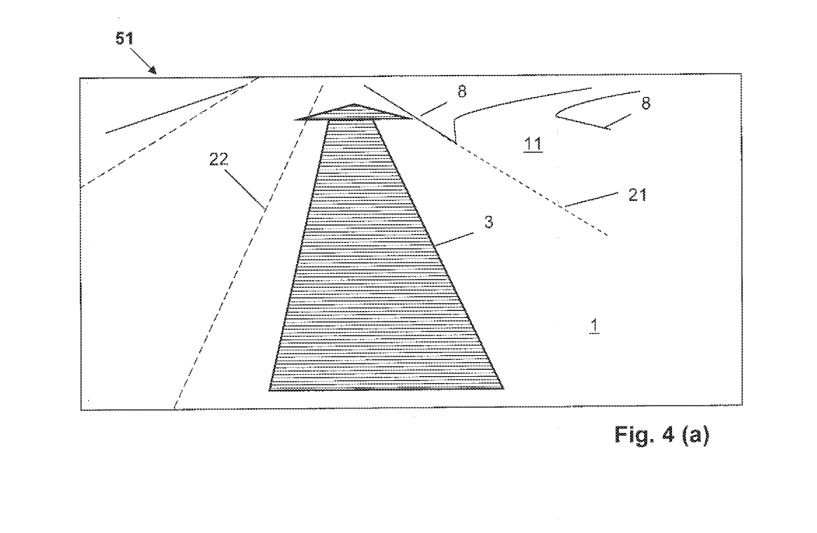

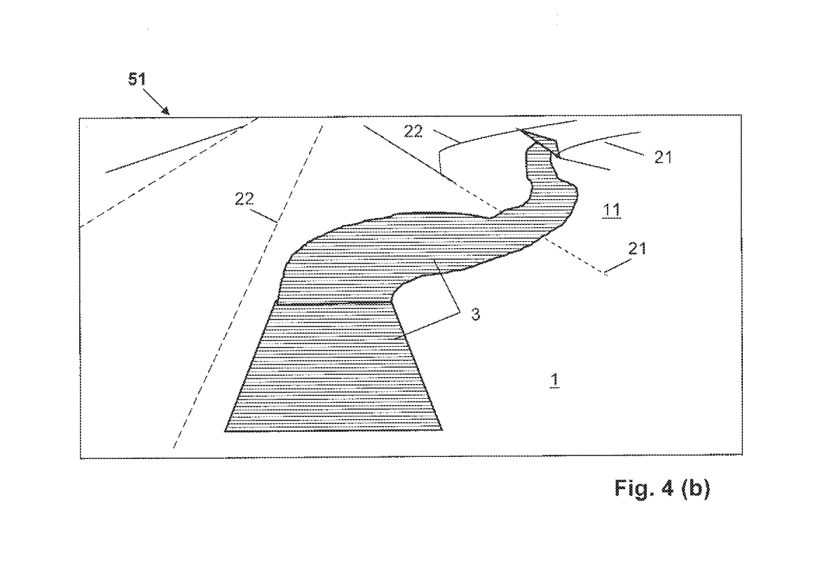

In all the example embodiments described hitherto, there are no obstacles, people or other vehicles 7′ on the roadway 1. The roadway course 8, the roadway boundaries 21, 22 and further environmental parameters U (see FIG. 6) are detected completely, so that the current driving maneuver 3 is planned and able to be carried out completely and free of error by the driver assistance system 10 in accordance with an embodiment (see FIG. 6). This is discernible for the motor vehicle driver 6 (see FIG. 4) in the display 5 for example owing to the completeness of the presented image objects for the roadway boundaries 21, 22 and the roadway course 8.

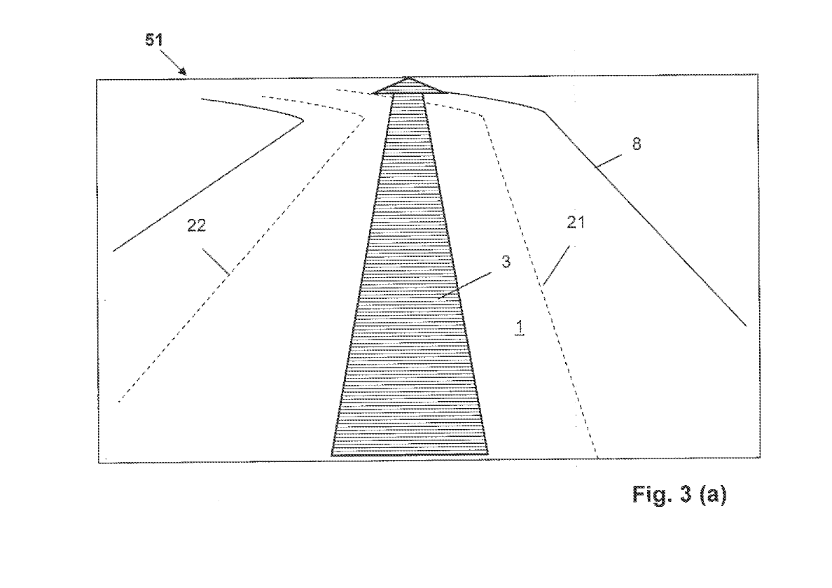

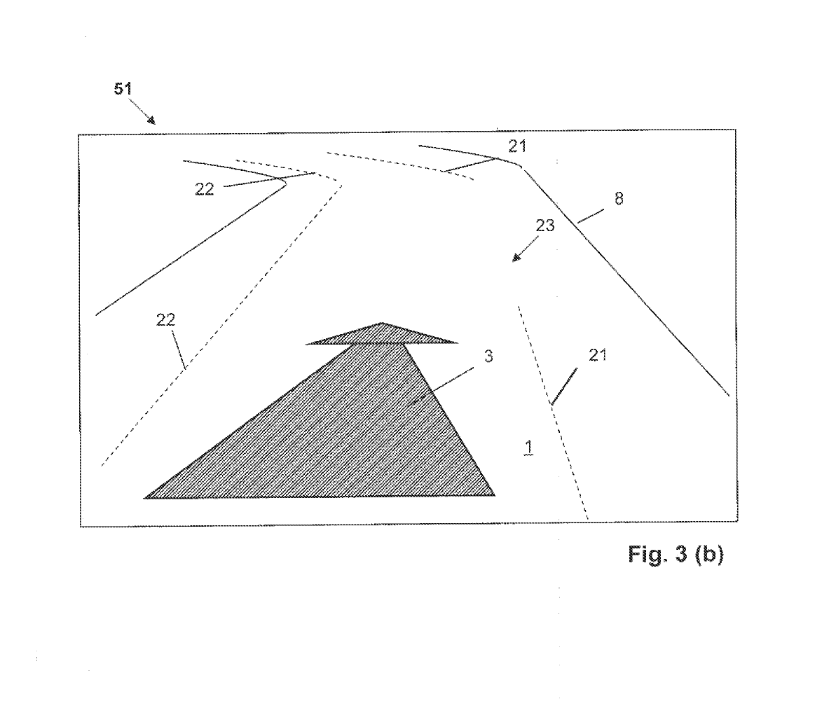

FIG. 3(a), on the other hand, shows an erroneous planning of the current driving maneuver, as could occur for example in very poor weather conditions. Although the roadway course 8 provides for a left bend, the image 51 shows as current driving maneuver 3 a travel straight ahead.

The error is immediately noticeable by the motor vehicle driver 6, because the arrow 3 presented for the current driving maneuver crosses the roadway boundary 21 and the roadway course 8. Therefore, the image 51 on the display 5 indicates immediately to the motor vehicle driver 6 the necessity to intervene into the driving event and to take over the driving of the motor vehicle 7.

FIG. 3 (b)-(e) show an incomplete planning of the current driving maneuver 3 owing to an incompletely present right roadway boundary 22.

Here, also, an intervention of the motor vehicle driver 6 is necessary, because the environmental parameters U necessary for the autonomous driving system 4 for planning the current driving maneuver 3 are not present. It is preferred that the arrow provided for the incompletely planned driving maneuver 3 clearly differs structurally and/or by color from that of the completely planned driving maneuver 3, so that the motor vehicle driver 6 becomes immediately aware of the incomplete planning. Such a structurally differing arrow is shown by FIG. 3(b) in comparison with the arrows shown in FIGS. 1(a) and 2(a). The selected image objects in FIG. 3 (c)-(e), on the other hand, correspond structurally to the selected image objects in FIG. 1 (b)-(d) or respectively FIG. 2 (b)-(d), but, owing to the incomplete planning are shorter and therefore nevertheless immediately recognizable as being erroneous.

In an embodiment, it is in addition preferred to give the motor vehicle driver 6 a further hazard notice in the form of a visual, acoustic or haptic signal, when a planning of the current or future driving maneuver 3, 3′ is not possible, for example because environmental data U are incomplete, or when an acute hazard situation is present. By way of example, for such an additional signal in FIG. 3 (c)-(e) a light signal 74 is shown in the cockpit.

FIG. 4(a) shows a roadway 1 with a junction, here a right turn-off 11. The current driving maneuver 3 provides for a travel straight ahead. FIG. 4 (b) shows the current driving maneuver 3 after an intervention of the motor vehicle driver 6, which the latter has indicated to the driver assistance system 10 for example by applying a blinker (not shown) or by a steering correction. Accordingly, the current driving maneuver 3 shown in FIG. 4(b) is a turn-off maneuver into the junction 11.

FIG. 5 shows the motor vehicle 7 following behind a motor vehicle 7′ which is travelling in front, with travel straight ahead. The cockpit is illustrated with the view through the windshield 71. The current driving maneuver 3, in an analogous manner to the illustrations of FIGS. 1 (d), 2 (d) and FIG. 3 (d), is presented by two structured areas extending within the roadway 1 and running along the roadway boundaries 21, 22. The vehicle 7′ which is travelling ahead is marked here by way of example by an encircling, luminous border.

A blinker display 73 is shown, in which the left blinker is illuminated. The motor vehicle driver 6 has therefore indicated here to the driver assistance system 10 his intension to pass. Accordingly, the driver assistance system 10 plans a passing of the motor vehicle 7′, which is travelling ahead, as a future driving maneuver 3′. This incompletely planned future driving maneuver 3′ is shown by an area, highlighted by color, which is represented here in gray. The area shows the driving space which the driver assistance system 10 has already recognized as a free driving space available for the motor vehicle 7. It is immediately recognizable here for the motor vehicle driver 6 that the planning of the passing maneuver is not yet completed, because on the one hand the image object for the driving maneuver 3 currently carried out shows a travel straight ahead, and because on the other hand the passing maneuver is still presented by an image object for a future driving maneuver 3′.

FIG. 6 shows diagrammatically the structure of the driver assistance system 10 according to an embodiment in a motor vehicle 7. The driver assistance system 10 comprises an autonomous driving system 4 and a display 5. The autonomous driving system 4 detects environmental parameters U, for example a roadway course 8, obstacles, vehicles and/or people in the current driving event, visibility and weather conditions and more, in particular by means of a camera, an ultrasound or radar apparatus and other detection means (not shown). In addition, the utilization of car to car systems and GPS systems (not shown) is preferred.

The environmental parameters U are compared with desired values for the environmental parameters U, which are necessary for a driving maneuver 3, 3′ which is carried out autonomously. The desired values for each autonomous driving maneuver 3, 3′ which is able to be carried out are stored for example on a data memory (not shown) of a processing unit 41 of the autonomous driving system 4. When all the necessary environmental parameters U are known and the driving maneuver is able to be carried out autonomously, this is presented in the presented image 51 of the display 5 by a corresponding arrow 3 or by another image object in the roadway course 8.

In addition, the autonomous driving system 4 detects driver-relevant data F of the motor vehicle driver 6, such as for example the steering on the steering wheel 71, accelerating or braking via the gas or the brake pedal (not shown), the applying of the blinker 74 and further actions. The detection takes place via an interface 64, so that the motor vehicle driver 6 can intervene into the autonomous driving maneuver 3, 3′ and alter or interrupt this.

For the detection, processing and evaluation and also the carrying out and presenting of the planned driving maneuver, the autonomous driving system 4 comprises the processing unit 41. The processing unit 41 of the autonomous driving system 4 according to the invention comprises in addition an interface 54 to the display 5, via which it conveys thereto the image data of the image 51 presented on the display 5.

The display 5 is configured here as a projector which projects the image 51 onto the windshield 71 of the motor vehicle 7, so that it is visible for the motor vehicle driver 6, without him having to turn his gaze from the roadway 1 and the actual driving event.

The autonomous driver assistance system 10 according to an embodiment is also suitable for the display of further driving maneuvers, for example a passing of a vehicle which is travelling ahead (not shown) or a reverse travel in an exit (not shown) or similar.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for informing a motor vehicle driver of a driving maneuver planned by a driver assistance system of a motor vehicle and carried out by the motor vehicle, wherein the method comprises the steps of:
detecting current environmental data of an environment lying ahead of the motor vehicle by a detection means;
planning and carrying out the driving maneuver on a basis of the current environmental data; and
reproducing the driving maneuver and at least a portion of the current environmental data in an image on a display.

2. The method according to claim 1, further comprising:
planning a future driving maneuver on a basis of the current environmental data; and
reproducing a feasibility of the future driving maneuver in the image.

3. The method according to claim 2, wherein the driving maneuver, the future driving maneuver, and the current environmental data are presented in the image respectively by an image object chosen from a line, an arrow, a box, a structured area, a circle, a wheel or a pair of wheels.

4. The method according to claim 2, wherein a presentation of the driving maneuver and a presentation of the future driving maneuver differ from one another in color and/or structurally.

5. The method of claim 2, wherein reproducing comprises displaying a presentation of the current environmental data and/or of the driving maneuver and the future driving maneuver in the image in a case of current environmental data detected as being implausible different in color and/or structurally from a presentation of the current environmental data and/or of the driving maneuver and the future driving maneuver in a case of current environmental data detected as being plausible.

6. The method according to claim 1, wherein detecting comprises detecting the current environmental data to include a roadway course and/or a roadway boundary.

7. The method according to claim 1, wherein detecting comprises detecting the current environmental data to include people, vehicles and/or obstacles and their relative position to the motor vehicle.

8. The method according to claim 1, wherein the driver assistance system detects driver-relevant data and takes this into account in planning a future driving maneuver.

9. The method according to claim 8, wherein the driver assistance system detects driver-relevant data chosen from a steering wheel position, a blinker position and/or a pedal position of a gas, brake and/or clutch pedal.

10. The method according to claim 1, wherein an incomplete presence of necessary environmental data is indicated acoustically and/or haptically.

11. A driver assistance system for a motor vehicle, wherein the driver assistance system comprises:
a driving system configured for planning a driving maneuver and executing autonomously the driving maneuver as a function of detected environmental data; and
a display configured for reproduction of an image in which the driving maneuver, as executed, and at least a portion of detected environmental data are presented figuratively.

12. The driver assistance system according to claim 11, wherein the display in addition indicates a future planned driving maneuver.

13. The driver assistance system according to claim 11, wherein the driver assistance system has an interface configured for detection of driver-relevant data.

14. The driver assistance system according to claim 11, wherein the display comprises a projector for reproduction of the image onto a projection area of the motor vehicle.

15. The driver assistance system according to claim 14, wherein the projection area is a windshield.

16. The driver assistance system according to claim 11, wherein the display is a head up display.

17. A motor vehicle with a driver assistance system comprising:
a driving system configured for planning a driving maneuver and executing autonomously the driving maneuver as a function of detected environmental data; and
a display configured for reproduction of an image in which the driving maneuver, as executed, and at least a portion of detected environmental data are presented figuratively.
